(19) United States
(12) Patent Application Publication
(10) Pub. No.: US 2012/0019010 A1
(43) Pub. Date: Jan. 26, 2012

(54) Fluid Machine

(75) Inventors: Shinji Nakamura, Isesaki-shi (JP); Hirofumi Wada, Saitama (JP)

(73) Assignee: SANDEN CORPORATION, Isesaki-shi (JP)

(21) Appl. No.: 13/260,729

(22) PCT Filed: Mar. 25, 2010
(86) PCT No.: PCT/JP2010/002124

§ 371 Date: Sep. 27, 2011

(30) Foreign Application Priority Data
Mar. 27, 2009 (JP) 2009-079021

(51) Int. Cl. H02K 7/18; F01K 23/06; F01D 15/12; F01D 15/08; F01D 15/10

(52) U.S. Cl. 290/1 R; 60/614

(57) ABSTRACT

Purpose: To provide a fluid machine, the production efficiency and maintenance characteristics of which can be improved while performance is ensured.

Means to attain the purpose: A fluid machine (14, 102, 108) has a plurality of fluid units (16, 20) that include rotating bodies (40, 66) and suck/discharge a working fluid along with the rotation of the rotating bodies, and a drive shaft (72) connected with the rotating bodies of the fluid units; and an Oldham's coupling (85) is mounted on a shaft portion between each two adjacent rotating bodies of the drive shaft.

### TECHNICAL FIELD

The present invention relates to a fluid machine, and more specifically, to a fluid machine that is suitable for use in a Rankine circuit of a waste heat recovery system for a vehicle.

### BACKGROUND ART

For example, a Rankine circuit constituting a waste heat recovery system for an internal combustion engine of a vehicle has a circulation path through which a working fluid (heat medium) circulates. A pump, an evaporator (heat exchanger), an expander, and a condenser are interposed in the circulation path in the order named. The pump is activated, for example, by an electric motor, and circulates the working fluid. The working fluid receives waste heat when passing through the evaporator, and expands the heat in the expander. As a result, the heat energy of the working fluid is converted into torque, discharged outside, and for example, used to rotate a fan for air-cooling the condenser.

Patent Document 1 discloses, as a fluid machine suitable for the Rankine circuit, a fluid machine in which a pump, an expander and a motor share a single drive shaft.

### PRIOR ART DOCUMENT

### Patent Document

Patent Document 1: Unexamined Japanese Patent Publication No. 2005-30386

### SUMMARY OF THE INVENTION

### Problem to be Solved by the Invention

In order to achieve a high production efficiency of a fluid machine with a plurality of fluid units like the one mentioned above, it is best to produce the fluid machine through the steps of evaluating the operation of each fluid unit, and assembling the fluid units that meet evaluation criteria. The fluid machine disclosed in Patent Document 1, however, has a drive shaft that is formed of a single member, so that it is difficult to evaluate the operation of an individual fluid unit.

Specifically, the load torque of the drive shaft is measured at the time of evaluating the operation of the turning mechanism of the expander. In this process, the rotating body of the pump is rotated along with the rotation of the drive shaft, reducing the accuracy of the measured load torque. This causes the problem that the expander is not be properly evaluated, and that the performance of the fluid machine cannot be ensured. Furthermore, if the expander or the pump malfunctions, the entire fluid machine needs to be dissembled to repair or exchange the malfunctioning unit. In the worst case, the fluid machine even has to be discarded due to the malfunctioning unit. In this view, the fluid machine disclosed in Patent Document 1 still has issues in improving the production efficiency and maintenance characteristics of the fluid machine.

The invention has been made in light of the foregoing matters. It is an object of the invention to provide a fluid machine, the production efficiency and maintenance characteristics of which can be improved while performance is ensured.

### Means for Solving the Problems

In order to accomplish the object, a fluid machine claimed in claim 1 has a plurality of fluid units including rotating bodies and sucking/discharging a working fluid along with rotation of the rotating bodies, and a drive shaft connected with the rotating bodies of the fluid units, the machine being characterized in that an Oldham's coupling is mounted on a shaft portion between each two adjacent rotating bodies of the drive shaft.

The invention claimed in claim 2 according to claim 1 is characterized in that the fluid units each include an expansion unit that has a first rotating body, and along with rotation of the first rotating body, receives the working fluid, expands the working fluid received, and then discharges the working fluid.

The invention claimed in claim 3 according to claim 1 or 2 is characterized in that the fluid units each include a pump unit that has a second rotating body, and along with rotation of the second rotating body, sucks the working fluid, pressurizes the sucked working fluid, and then discharges the working fluid.

The invention claimed in claim 4 according to any one of claims 1 to 3 is characterized in that the fluid units each include a compression unit that has a third rotating body, and along with rotation of the third rotating body, sucks the working fluid, compresses the sucked working fluid, and then discharges the working fluid.

The invention claimed in claim 5 according to any one of claims 1 to 4 is characterized by including a power generation unit that has a fourth rotating body connected to the drive shaft and generates electric power along with rotation of the fourth rotating body.

The invention claimed in claim 6 according to any one of claims 1 to 4 is characterized by including a power generation drive unit that has a fifth rotating body connected to the drive shaft, generates electric power along with rotation of the fifth rotating body, and also rotates the fifth rotating body through external power supply to activate the drive shaft along with the rotation of the fifth rotating body.

The invention claimed in claim 7 according to any one of claims 1 to 6 is characterized by including a power transmission unit that is connected to the drive shaft and transmits power between the drive shaft and the outside.

### Advantageous Effects of the Invention

The fluid machine of the invention claimed in claims 1 to 7 includes the fluid units that suck/discharge the working fluid along with the rotation of the rotating bodies, and the drive shaft connected with the rotating bodies of the fluid units. The Oldham's coupling is mounted on the shaft portion between each two adjacent rotating bodies of the drive shaft. At the time of producing the fluid machine, each of the fluid units is separated at the Oldham's coupling, and the operation of the fluid units is individually evaluated. This makes it possible to evaluate the operation of the fluid units properly, and to improve the production efficiency of the fluid machine while ensuring the performance of the fluid machine.

It is possible, if there is a malfunction in any one of the fluid units, to separate only the malfunctioning unit at the Oldham's coupling for repair or exchange. It is not necessary to dissemble the entire fluid machine to exchange the malfunctioning unit, which improves the maintenance characteristics of the fluid machine. Moreover, the Oldham's coupling has a simple configuration as compared to a fastened configuration using splines or the like, so that the centering of the fluid unit at the time of the operation evaluation can be carried out with comparative ease. This contributes to a further improvement of production efficiency of the fluid machine.

The Oldham's coupling allows the shaft to be displaced in a radial direction. At the same time, the Oldham's coupling reduces a rotation angle error that is caused by shaft misalignment (offset misalignment, angular misalignment), and is thus capable of transmitting a rotation angle with high accuracy. This allows shaft misalignment when the fluid units are united together, thereby ensuring the performance of the fluid machine.

### BRIEF DESCRIPTION OF THE DRAWINGS

FIG. 1 is a schematic view showing the configuration of a waste heat recovery system for a vehicle, in which a fluid machine of a first embodiment is installed;

FIG. 2 is a schematic vertical cross-sectional view of the fluid machine applied to the system shown in FIG. 1;

FIG. 3 is a schematic vertical cross-sectional view of a fluid machine of a second embodiment; and

FIG. 4 is a schematic vertical cross-sectional view of a fluid machine of a third embodiment.

### BEST MODE OF CARRYING OUT THE INVENTION

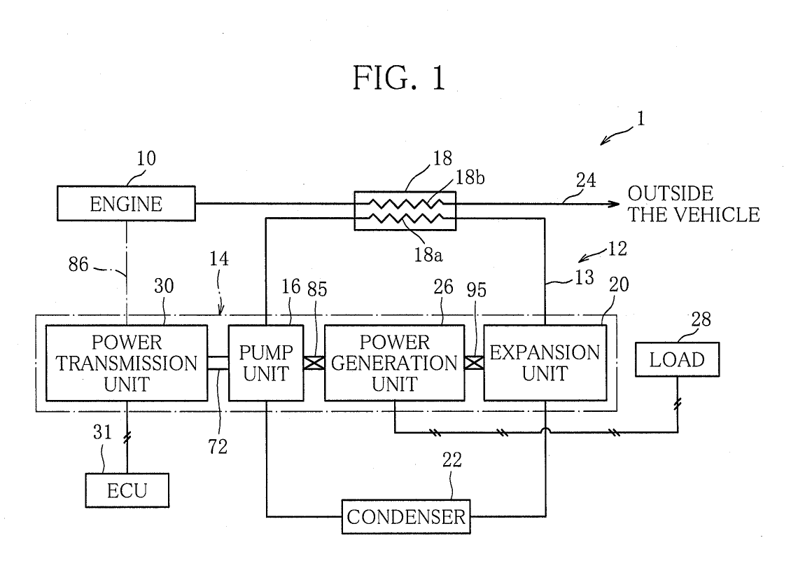

FIG. 1 shows a waste heat recovery system 1 for using a fluid machine 14 according to a first embodiment. The waste heat recovery system 1, for example, recovers the heat of exhaust gas discharged from a vehicle engine (internal combustion engine) 10. To this end, the waste heat recovery system 1 has a Rankine circuit 12. The Rankine circuit 12 includes a circulation path 13 through which a working fluid (heat medium) circulates. The circulation path 13 is formed, for example, of a tube or a pipe.

A pump unit (fluid unit) 16 of the fluid machine 14 is interposed in the circulation path 13 for the working fluid to flow therethrough. A heater 18, an expansion unit (fluid unit) 20 of the fluid machine 14, and a condenser 22 are interposed downstream of the pump unit 16 in the order named as viewed in a flowing direction of the working fluid. The pump unit 16 sucks the working fluid on the condenser 22 side, pressurizes the sucked working fluid, and then discharges the working fluid toward the heater 18. The working fluid discharged from the pump unit 16 is in a low-temperature and high-pressure liquid state.

The heater 18 is a heat exchanger and includes a low-temperature flow path 18a constituting a part of the circulation path 13 and a high-temperature flow path 18b capable of exchanging heat with the low-temperature flow path 18a. The high-temperature flow path 18b is, for example, interposed in an exhaust duct 24 extending from the engine 10. When passing through the heater 18, therefore, the working fluid in the low-temperature and high-pressure liquid state receives the heat of the exhaust gas produced in the engine 10. In this way, the working fluid is heated and brought into a high-temperature and high-pressure superheated vapor state.

The expansion unit 20 of the fluid machine 14 expands the working fluid that has come into the superheated vapor state. The working fluid then comes into a high-temperature and low-pressure superheated vapor state. The condenser 22 is a heat exchanger, which condenses the working fluid flowed out of the expansion unit 20 by exchanging heat with outside air and brings the working fluid into a low-temperature and low-pressure liquid state. An electric fan, not shown, is placed near the condenser 22, so that the working fluid is refrigerated by the wind coming from a front part of the vehicle and also by the wind from the electric fan. The working fluid refrigerated in the condenser 22 is sucked again into the pump unit 16 and circulates through the circulation path 13.

In this specification, the expansion unit 20 is capable not only of expanding the working fluid but also of converting the heat energy of the working fluid into torque (rotating force) and outputting the torque. In order to make use of the torque that is outputted from the expansion unit 20, a power generation unit 26 as well as the pump unit 16 is connected to the expansion unit 20. The power generation unit 26 is properly connected with an electrical load 28, such as a battery, which uses or stores a generated electric power.

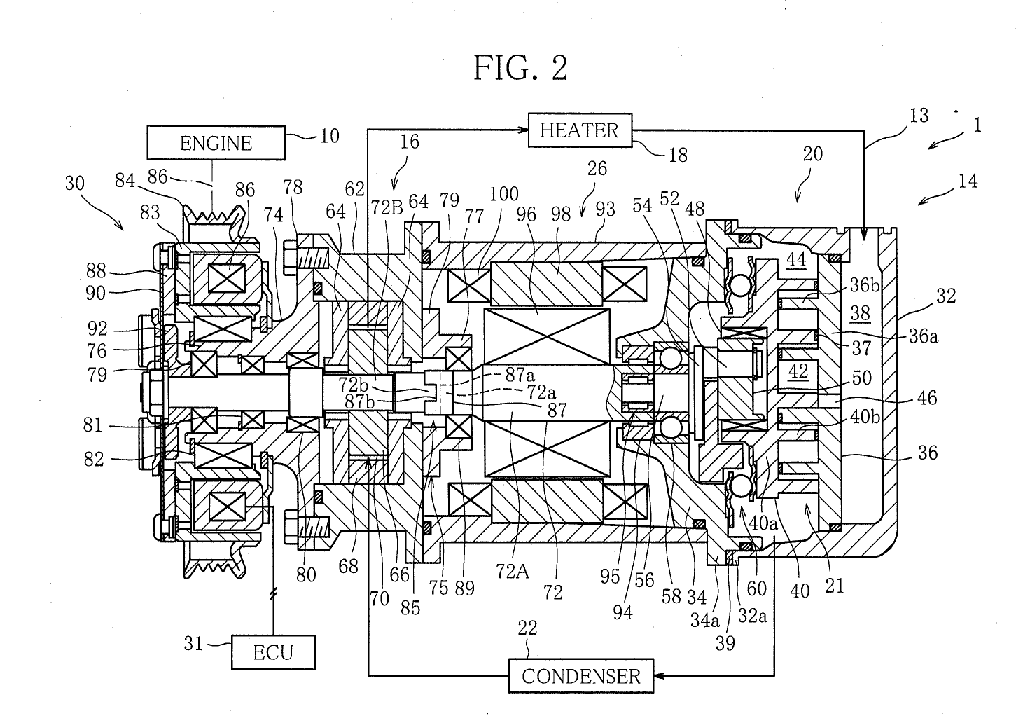

The fluid machine 14 has a power transmission unit 30 for inputting/outputting the torque. The power transmission unit 30 is, for example, an electromagnetic clutch. The electromagnetic clutch is operated by an ECU (electrical control unit) 31 and is capable of intermittently transmitting the torque. As shown in FIG. 2, the expansion unit 20, the power generation unit 26 and the pump unit 16 are serially connected together in the order named.

The expansion unit 20 is a scroll expander using a turning mechanism 21 as a drive member. An opening of a cup-shaped casing 32 (expansion unit casing) of the expansion unit 20 is substantially covered with a partition wall 34. The partition wall 34 has a through-hole at the center. A fixed scroll 36 is fixed in the expansion unit casing 32. A high-pressure chamber 38 is separated off in the rear of the fixed scroll 36. The high-pressure chamber 38 leads to the heater 18 through an inlet port formed in the expansion unit casing 32 and a part of the circulation path 13 connected to the inlet port.

A movable scroll (rotating body, a first rotating body) 40 is placed in front of the fixed scroll 36 so as to engage with the fixed scroll 36. An expansion chamber 42 that expands the working fluid is separated off between the fixed scroll 36 and the movable scroll 40. A space around the movable scroll 40 is separated off as a low-pressure chamber 44 that receives the expanded working fluid. An introduction hole 46 is formed through a substrate of the fixed scroll 36 at a substantial center thereof. Through the introduction hole 46, the expansion chamber 42 and the high-pressure chamber 38 positioned at a radial center of the fixed and movable scrolls 36 and 40 communicate with each other.

When the working fluid is expanded within the expansion chamber 42 located at the radial center, the capacity of the expansion chamber 42 is increased, and the expansion chamber 42 moves in a radially outward direction along spiral walls of the fixed and movable scrolls 36 and 40. The expansion chamber 42 eventually communicates with the low-pressure chamber 44, and the expanded working fluid flows into the low-pressure chamber 44. The low-pressure chamber 44 leads to the condenser 22 through an outlet port, not shown, and a part of the circulation path 13 connected to the outlet port.

Along with the expansion of the working fluid, the movable scroll 40 is brought into an orbital motion relative to the fixed scroll 36. This orbital motion is converted by the turning mechanism 21 into a rotational motion. More specifically, a boss is integrally formed in a rear face of a substrate of the movable scroll 40, and an eccentric bushing 50 is placed in the boss with a needle bearing 48 intervening therebetween so as to be able to make a relative rotation. A crank pin 52 is inserted in the eccentric bushing 50 and is eccentrically protruding from a circular disc 54. A shaft portion 56 is integrally protruding from the disc 54 on the opposite side to the crank pin 52 to be coaxial with the crank pin 52. The shaft portion 56 is rotatably supported by the partition wall 34 through a radial bearing 58 such as a ball bearing. In short, the movable scroll 40 is rotatably supported by the partition wall 34, and the orbital motion of the movable scroll 40 is converted into the rotational motion of the shaft portion 56.

The turning mechanism 21 has, for example, a ball coupling 60 to inhibit the rotation of the movable scroll 40 during orbital motion and receive thrust pressure. The ball coupling 60 is placed between an outer circumference of the substrate of the movable scroll 40 and the partition wall 34 opposed to the outer circumference. Along with the operation of the turning mechanism 21, the fixed and movable scrolls 36 and 40 come into sliding contact with each other leaving a small space therebetween.

The fixed and movable scrolls 36 and 40 are formed of substrates 36a and 40a, and spiral wraps 36b and 40b, respectively, which are integrally situated in inner faces of the substrates 36a and 40a. Tip seals 37 are provided to tip ends of the spiral wraps 36b and 40b. Through the tip seals 37, the spiral wraps 36b and 40b come into sliding contact with the substrates 40a and 36a, respectively, which are located opposite to the spiral wraps 36b and 40b, with a small space left therebetween. The local sliding contact between the spiral walls of the spiral wraps 36b and 40b creates the expansion chamber 42 spiraling around the axes of the substrates 36a and 40a.

The spaces formed between the spiral wrap 36b and the opposed substrate 40a and between the spiral wrap 40b and the opposed substrate 36a, that is, the spaces between the fixed and movable scrolls 36 and 40, are ensured by forming a space between jointed faces of the expansion unit casing 32 and the partition wall 34. The jointed faces are formed of an end wall 32a of the expansion unit casing 32 and an end wall 34a of the partition wall 34. A shim 39 serving as a pinch plate, for example, made of metal and shaped like a ring, is pinched between the end walls 32a and 34a. The length of the space between the fixed and movable scrolls 36 and 40 can be adjusted by changing the thickness of the shim 39 and the number thereof when the expansion unit casing 32 and the partition wall 34 are connected to each other with a connecting bolt, not shown. By so doing, a pressure of the movable scroll 40 which acts on the fixed scroll 36 in an axial direction of a drive shaft 72 is evenly and reliably received on the expansion unit casing 32 side during the operation of the expansion unit 20.

The adjustment of length of the space between the fixed and movable scrolls 36 and 40 is carried out in light of the operation evaluation of the expansion unit 20 as to whether the movable scroll 36 makes a smooth orbital motion relative to the fixed scroll 40.

According to a method of adjusting the space length, the fixed and movable scrolls 36 and 40 are tentatively fit together, and a torque sensor (evaluator) such as a motor, not shown, is connected to the drive shaft 72, thereby measuring a load torque when the drive shaft 72 is rotated. The length of the space between the fixed and movable scrolls 36 and 40 is estimated from the load torque. If the length of the space between the fixed and movable scrolls 36 and 40, which is estimated from the measured value of the load torque, falls in an allowable range that is defined by an upper limit and a lower limit, the fixed and movable scrolls 36 and 40 are firmly fitted together. By conducting the above-described load torque inspection process that is one of the processes of producing the fluid machine 14, the length of the space between the fixed and movable scrolls 36 and 40 is controlled.

The pump unit 16 is, for example, a trochoid pump, but may be a gear pump. The pump unit 16 has a cylindrical casing (pump unit casing 62) whose ends are both open. A pair of ring-like covers 64 is placed in the pump unit casing 62 leaving a predetermined space therebetween. An internal gear (rotating body, a second rotating body) 66 is rotatably placed between the covers 64, and an external gear 68 is fixed so as to surround the internal gear 66.

A pump chamber 70 that pressurizes the working fluid along with rotation of the internal gear 66 is separated off between the internal gear 66 and the external gear 68. The working fluid is sucked from the condenser 22 into the pump chamber 70 through a suction port, not shown, and a part of the circulation path 13 connected to the suction port. The working fluid pressurized in the pump chamber 70 is discharged toward the heater 18 through a discharge port, not shown, and a part of the circulation path 13 connected to the discharge port.

In order to rotate the internal gear 66, the internal gear 66 is fixed to the drive shaft 72 to be able to rotate integrally with the drive shaft 72. A first end of the drive shaft 72 is connected with an electromagnetic clutch serving as the power transmission unit 30 described below, and a second end with the shaft portion 56 of the turning mechanism 21 through a one-way clutch 95 mentioned below.

In the drive shaft 72, an Oldham's coupling 85 is mounted on a shaft portion between the movable scroll 40 and the internal gear 66. The Oldham's coupling 85 is a conventional coupling that is capable of transmitting a rotational driving force while sliding a fitted section between a protrusion and a groove. Hubs 72a and 72b as protrusions are integrally formed in or jointed to an end face of a driving shaft portion 72A on the side of the power generation unit 26 and the expansion unit 20 of the drive shaft 72 and an end face of a driven shaft portion 72B on the pump unit 16 side of the drive shaft 72. Disposed between the hubs 72a and 72b is a slider 87 having grooves 87a and 87b formed in faces opposed to the hubs 72a and 72b so as to be located at positions orthogonal to a radial direction of the drive shaft 72. The torque sensor used in the operation evaluation of the expansion unit 20 is connected to the hub 72a.

The Oldham's coupling 85 allows the drive shaft 72 to be radially displaced between the driving shaft portion 72A and the driven shaft portion 72B. The Oldham's coupling 85 also reduces a rotation angle error of the drive shaft 72, which is caused by shaft misalignment accompanied by offset misalignment or angular misalignment between the driving shaft portion 72A and the driven shaft portion 72B, and transmits a rotation angle of the driving shaft portion 72A to the driven shaft portion 72B with high accuracy. The drive shaft 72 provided with the Oldham's coupling 85 runs through the covers 64 and the pump unit casing 62, and also runs through lid members 74 and 75 fixed at the open ends of the pump unit casing 62. The lid member 74 is formed of a cylinder 76 and a flange 78, and the lid member 75 is formed of a cylinder 77 and a flange 79. The flanges 78 and 79 are joined to the open ends of the pump unit casing 62.

Radial bearings 79 and 80 are placed in the cylinder 76 to be located at both ends of the cylinder 76. A radial bearing 89 is placed in the cylinder 77. The cylinders 76 and 77 support the drive shaft 72 through the radial bearings 79, 80 and 89 so as to allow the rotation of the drive shaft 72. A shaft seal member 81 such as a lip seal is placed in the cylinder 76 and airtightly partitions the cylinder 76.

An electromagnetic clutch serving as the power transmission unit 30 is connected to the first end of the drive shaft 72, which is protruding from the cylinder 76. The power transmission unit 30 has a rotor 83 that is placed outside the cylinder 76 through a radial bearing 82. A pulley 84 is fixed onto an outer periphery of the rotor 83. A belt 86 shown by a dashed line is hung between the pulley 84 and a pulley of the engine 10, so that the pulley 84 and the rotor 83 can be rotated, for example, by being supplied with electric power from the engine 10. A solenoid 86 is placed in the rotor 83 and generates a magnetic field in response to supply of electric power from the ECU 31.

A ring-like armature 88 is placed near an end face of the rotor 83. The armature 88 is connected to a boss 92 through an elastic member 90 such as a blade spring. The boss 92 is splined to the first end of the drive shaft 72, enabling the armature 88 to rotate integrally with the drive shaft 72. Due to the magnetic field of the solenoid 86, the armature 88 can be attached to the end face of the rotor 83 while resisting a biasing force of the elastic member 90. This makes it possible to transmit electric power between the rotor 83 and the armature 88.

A cylindrical casing (power generation unit casing) 93 of the power generation unit 26 is located between the partition wall 34 and the pump unit casing 62. The expansion unit casing 32, the partition wall 34, the power generation unit casing 93, the pump unit casing 62, and the lid member 74 are connected together, and constitute a housing for the fluid machine 14.

The second end of the drive shaft 72 extends to reach the through-hole of the partition wall 34 and is rotatably supported by the partition wall 34 through a needle bearing 94. The one-way clutch 95 serving as a connecting member is fixed to an inner side of the second end of the drive shaft 72. The second end of the drive shaft 72 and the shaft portion 56 of the turning mechanism 21 are connected to each other through the one-way clutch 95. When the shaft portion 56 and the drive shaft 72 rotate in the same direction, if the shaft portion 56 has a lower rotational frequency than the drive shaft 72, the one-way clutch 95 blocks the power transmission between the shaft portion 56 and the drive shaft 72. When the rotational frequency of the shaft portion 56 is about to become higher than that of the drive shaft 72, the one-way clutch 95 allows the power transmission between the shaft portion 56 and the drive shaft 72, and the shaft portion 56 and the drive shaft 72 rotate integrally with each other.

A rotor (forth rotating body) 96 is fixed to a portion of the drive shaft 72, which extends through the power generation unit casing 93. The rotor 96 is made, for example, of permanent magnet. The rotor 96 is positioned coaxially with the shaft portion 56 and the internal gear 66. A stator is fixed onto an inner circumferential surface of the power generation unit casing 93 so as to surround the rotor 96. The stator has a yoke 98 and, for example, three pairs of coils 100 wound around the yoke 98. The coils 100 are arranged to generate an alternating current of three phases along with rotation of the rotor 96. The generated alternating current is supplied to the external load 28 through an outgoing line, not shown.

The power generation unit 26 does not function as an electric motor, so that the shape of the yoke 98, the number of winding of the coils 100, and the like, are designed to ensure a high power generation efficiency. The usage of the waste heat recovery system 1 for a vehicle will be described below, mainly about the operation of the fluid machine 14 and of the Rankine circuit 12.

### <Activation>

When the ECU 31 turns on the power transmission unit 30 to activate the Rankine circuit 12, the power of the engine 10 is inputted to the drive shaft 72. In response to the rotation of the drive shaft 72, the internal gear 66 of the pump unit 16 is rotated, and the pump unit 16 sucks the working fluid on the upstream side, pressurizes the sucked working fluid, and discharges the working fluid on the downstream side.

In result, the working fluid circulates through the circulation path 13 to be heated by the heater 18 and expanded by the expansion unit 20. Immediately after the activation of the Rankine circuit 12, the working fluid in the circulation path 13 has a low pressure. The rotational frequency of the movable scroll 40, or the rotational frequency of the shaft portion 56 of the turning mechanism 21, is therefore lower than that of the drive shaft 72. The one-way clutch 95 blocks power transmission between the shaft portion 56 and the drive shaft 72.

### <Autonomous Operation and Power Generation>

After the activation of the Rankine circuit 12, when the pressure of the working fluid in the circulation path 13 is sufficiently increased, the rotational frequency of the shaft portion 56 of the turning mechanism 21 tends to rise higher than that of the drive shaft 72. Once the rotational frequency of the shaft portion 56 of the turning mechanism 21 in a free state becomes higher than that of the drive shaft 72, the one-way clutch 95 comes into a locked state, and the shaft portion 56 and the drive shaft 72 are rotated integrally with each other.

When the torque transmitted from the shaft portion 56 to the drive shaft 72 becomes high enough to operate the pump unit 16, the ECU 31 turns off the power transmission unit 30 and blocks the power supply from the engine 10. The fluid machine 14 shifts to an autonomous operation that operates the pump unit 16 by using the torque generated in the expansion unit 20. Meanwhile, in response to the rotation of the drive shaft 72, the rotor 96 of the power generation unit 26 is rotated, and the power generation unit 26 creates alternating current. The alternating current is supplied to the load 28, and is properly accumulated or consumed by the load 28. The load 28 may include a rectifier that converts the alternating current into direct current.

### <Regenerative Brake>

After the fluid machine 14 shifts to the autonomous operation, the load of the engine 10 is reduced. At the time of the braking or deceleration of the vehicle, the ECU 31 may turn on the power transmission unit 30, that is, may engage an electromagnetic clutch. The fluid machine 14 thus functions as a regenerative brake. Consequently, a supplementary load for deceleration is applied to the engine 10, and moreover, the power generation unit 26 generates power, thereby converting a kinetic energy of the vehicle into electric power.

### <Other Matters>

It is possible to supply the torque of the fluid machine 14 to the engine 10 without shifting the fluid machine 14 to the autonomous operation. In other words, among the torque generated in the expansion unit 20, a portion surpassing the torque consumed in the pump unit 16 and the power generation unit 26 may be outputted through the power transmission unit 30 to the engine 10. As described above, in the fluid machine 14 of the first embodiment, the drive shaft 72 is connected with the movable scroll 40 through the shaft portion 56 and with the internal gear 66 of the pump unit 16, and the Oldham's coupling 85 is mounted on the shaft portion between the movable scroll 40 and the internal gear 66 of the drive shaft 72. At the time of producing the fluid machine 14, the expansion unit 20 is separated at the pump unit 16 and the Oldham's coupling 85, and the operation of the expansion unit 20 evaluated individually. In this way, the operation of the expansion unit 20 can be accurately evaluated, ensuring the performance of the fluid machine 14 and improving the production efficiency.

More specifically, it is prevented that friction is created by the rotation of internal gear 66 of the pump unit 16, which accompanies the rotation of the drive shaft 72, and causes an error in results of the load torque measurement when the operation of the turning mechanism 21 is evaluated by measuring the load torque of the drive shaft 72. This enables an accurate evaluation of the expansion unit 20. If there is a malfunction in the pump unit 16, it is possible to separate only the pump unit 16 at the Oldham's coupling 85 for repair or exchange. It is therefore unnecessary to dissemble the entire fluid machine 14 for the repair or exchange of the pump unit 16, which improves the maintenance characteristics of the fluid machine 14.

Furthermore, the relatively simple configuration of the Oldham's coupling makes it possible to comparatively easily carry out the centering for connecting the torque sensor to the hub 72a in the operation evaluation of the expansion unit 20. This contributes to a further improvement of the production efficiency of the fluid machine. The Oldham's coupling 85 allows the radial displacement of a shaft. At the same time, the Oldham's coupling 85 reduces a rotation angle error that is caused by shaft misalignment (offset misalignment, angular misalignment), and is thus capable of transmitting a rotation angle with high accuracy. This allows shaft misalignment that is caused when the units 16 and 20 are united together, thereby ensuring the performance of the fluid machine 14.

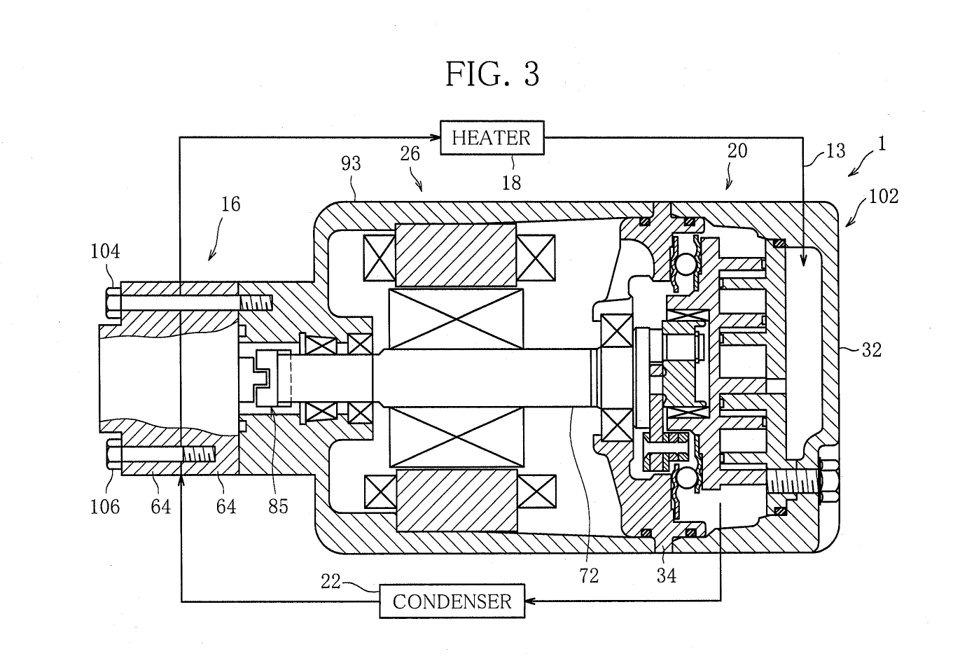

FIG. 3 shows a fluid machine 102 of a second embodiment. The constituents identical to those of the fluid machine 14 of the first embodiment will be provided with the identical reference marks, and the description thereof will be omitted; or alternatively, reference marks will be omitted. The fluid machine 102 does not have the power transmission unit 30. The internal gear 66, not shown in FIG. 3, of the pump unit 16 is connected to a first end of the fluid machine 102, which is located on the opposite side to the Oldham's coupling 85 of the driven shaft portion 72B.

The fluid machine 102 does not have the pump unit casing 62. The pump unit 16 is fastened to the open end of the power generation unit casing 93 with two through bolts 104 by use of a pair of covers 64. The through bolts 104 are arranged in opposite positions to each other in the covers 64, and screwed in from the outside of the fluid machine 102. The covers 64 are fastened together with two connecting bolts 106. The connecting bolts 106 are arranged in different opposite positions to each other than the positions of the through bolts 104, and screwed in from the outside of the fluid machine 102. In short, the expansion unit casing 32, the partition wall 34, the power generation unit casing 93 and the covers 64 are connected together, thereby constituting a single housing for the fluid machine 102.

In the fluid machine 102, the Oldham's coupling 85 is disposed closer to the pump unit 16 than the radial bearing 89 of the drive shaft 72. In the case of the fluid machine 102, it is easy to configure the housing of the fluid machine 102 that is not provided with the power transmission unit 30. The pump unit 16 is fixed by fastening the through bolts 104 from the outside of the fluid machine 102. The fastening of the through bolts 104 can be carried out from the same direction as that of the connecting bolts 106, which further improves the production efficiency of the fluid machine 102.

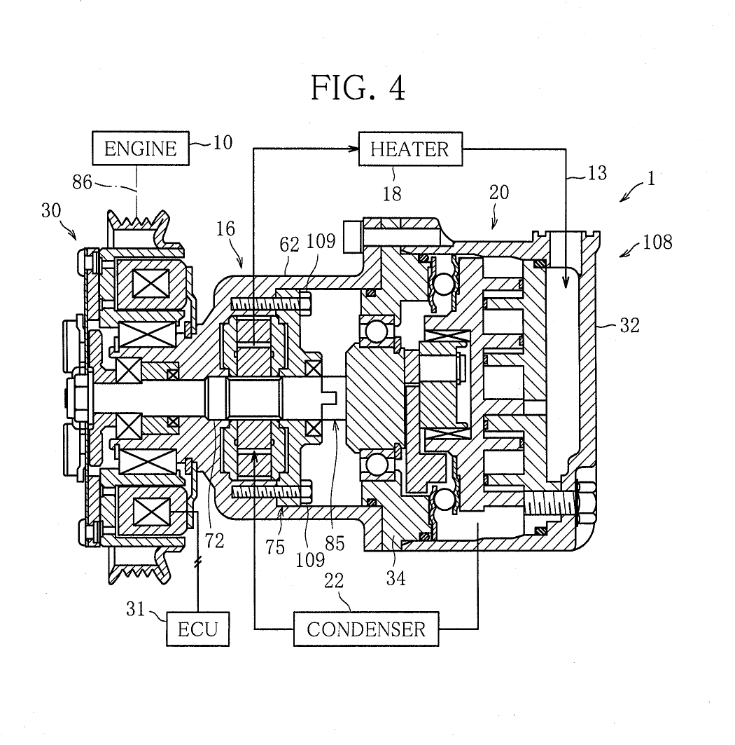

FIG. 4 shows a fluid machine 108 of a third embodiment. The constituents identical to those of the fluid machines 14 and 102 of the first and second embodiments will be provided with the identical reference marks, and the description thereof will be omitted; or alternatively, reference marks will be omitted. The fluid machine 108 does not have the power generation unit 26, so that the pump unit casing 62 is fastened to the expansion unit casing 32 through the partition wall 34.

The fluid machine 108 does not have the lid member 74. Instead, the pump unit casing 62 extends to a position in which the lid member 74 is normally disposed. In other words, the expansion unit casing 32, the partition wall 34 and the pump unit casing 62 are connected together, thereby constituting a single housing for the fluid machine 108, and arranging the Oldham's coupling 85 within the pump unit casing 62.

The pump unit 16 is fastened to the pump unit casing 62 with a plurality of through bolts 109 through the lid member 75. The through bolts 109 are screwed in from the inside of the pump unit casing 62. In the case of the fluid machine 108, it is easy to configure the housing for the fluid machine 108 that is not provided with the power generation unit 26. This further improves the production efficiency of the fluid machine 108.

The pump unit 16 is fastened to the pump unit casing 62 from the inside of the pump unit casing 62, that is, the inside of the fluid machine 108. Sealed points in the housing of the fluid machine 108 are one less than in the first embodiment. This reduces the risk of leakage of the working fluid from the housing and further improves the reliability of the fluid machine 108.

Although not shown in the drawings, the invention is not limited to the first to third embodiments, and may be modified in various ways. For example, the Oldham's coupling 85 may be mounted on the shaft portion of the drive shaft 72 between the expansion unit 20 and the power generation unit 26. It is also possible to eliminate the partition wall 34, connect the expansion unit casing 32 directly to the pump unit casing 62 to increase the capacity of the expansion unit casing 32, and dispose the Oldham's coupling 85 in the expansion unit casing 32 where there is the working fluid of the low-pressure chamber 44. In this case, the partition wall 34 and the radial bearing 58 are unnecessary, which makes simple the configuration of the fluid machine. This further improves the production efficiency of the fluid machine.

It is preferable that the Oldham's coupling 85 be provided with a surface hardening treatment such as a nitriding treatment because this improves the durability of the Oldham's coupling 85 and the reliability of the fluid machine. It is also possible to configure a fluid machine in which a compression unit (fluid unit) that sucks the working fluid along with the orbital motion of the movable scroll (rotating body, first rotating body), compresses the sucked working fluid, and discharges the working fluid is connected to the expansion unit 20 and the pump unit 16. If the compression unit is connected to the expansion unit 20, it is possible to evaluate the operations thereof individually after separating the turning mechanism of the compression unit and that of the expansion unit 20 at the Oldham's coupling 85. This further improves the production efficiency of the fluid machine.

An oil feeding path, through which lubrication oil for lubricating the turning mechanisms flows, may be formed by drilling in the drive shaft 72. It is especially preferable that the compression unit be connected to the expansion unit 20 because the lubrication oil can be circulated between the compression unit and the expansion unit 20, and this enables a smooth lubrication of the turning mechanisms of the compression unit and the expansion unit 20. Although, in the first to third embodiments, the pump unit 16 is of a trochoid type, the pump unit is not limited to any particular type.

There is no particular limitation on the arrangement of the pump unit 16, the power generation unit 26, the expansion unit 20 and the like. It is possible to utilize, instead of the power generation unit 26, a motor generator (power generation drive unit) that is produced by providing the power generation unit 26 with a function as a motor. This motor generator includes a rotor (fifth rotating body) and has a power generation function that generates electric power along with the rotation of the rotor. The motor generator can also function as a motor that rotates the rotor through external power supply and drives the drive shaft 72 along with the rotation of the rotor.

The fluid machine of the invention may be applied not only to the Rankine circuit 12 of the waste heat recovery system 1 for a vehicle but also to any refrigeration circuits through which a working fluid circulates.

### INDUSTRIAL APPLICABILITY

The invention is suitable as a fluid machine that is used in a Rankine circuit constituting a waste heat recovery system for an internal combustion engine such as a vehicle engine.

### REFERENCE NUMERALS

14, 102, 108 fluid machine
16 pump unit (fluid unit)
20 expansion unit (fluid unit)
26 power generation unit
30 power transmission unit
40 movable scroll (rotating body, first rotating body)
66 internal gear (rotating body, second rotating body)
72 drive shaft
85 Oldham's coupling
96 rotor (fourth rotating body)

1. A fluid machine comprising:
a plurality of fluid units including rotating bodies and sucking/discharging a working fluid along with rotation of the rotating bodies, and a drive shaft connected with the rotating bodies of the fluid units, characterized in that:
an Oldham's coupling is mounted on a shaft portion between each two adjacent rotating bodies of the drive shaft.

2. The fluid machine according to claim 1, wherein the fluid units each include an expansion unit that has a first rotating body, and along with rotation of the first rotating body, receives the working fluid, expands the working fluid received, and then discharges the working fluid.

3. The fluid machine according to claim 1, wherein the fluid units each include a pump unit that has a second rotating body, and along with rotation of the second rotating body, sucks the working fluid, pressurizes the sucked working fluid, and then discharges the working fluid.

4. The fluid machine according to claim 1, wherein the fluid units each include a compression unit that has a third rotating body, and along with rotation of the third rotating body, sucks the working fluid, compresses the sucked working fluid, and then discharges the working fluid.

5. The fluid machine according to claim 1, comprising a power generation unit that has a fourth rotating body connected to the drive shaft and generates electric power along with rotation of the fourth rotating body.

6. The fluid machine according to claim 1, comprising a power generation drive unit that has a fifth rotating body connected to the drive shaft, generates electric power along with rotation of the fifth rotating body, and also rotates the fifth rotating body through external power supply to activate the drive shaft along with the rotation of the fifth rotating body.

7. The fluid machine according to claim 1, comprising a power transmission unit that is connected to the drive shaft and transmits power between the drive shaft and the outside.
